(19) United States
(12) Patent Application Publication
(10) Pub. No.: US 2008/0114691 A1
(43) Pub. Date: May 15, 2008

(54) PROCESSING TRANSACTIONS

(76) Inventor: Chuck Foster, Yountville, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/554,865

(22) Filed: Oct. 31, 2006

(51) Int. Cl. H04L 9/00

(52) U.S. Cl. 705/52

(57) ABSTRACT

A system and method of terminating a transaction between a merchant and customer are disclosed.

### BACKGROUND

1. Field

The subject matter disclosed herein related to processing transactions between a seller and a customer.

2. Information

Technological advances in financial services have enabled efficient non-cash transactions between merchants and customers. The evolution of credit cards and debit cards have enabled efficient payment for goods and/or services without the use of cash. In such non-cash transactions, a merchant typically receives information regarding a credit and/or debit card, which is then used to process payment with a financial institution that issues the credit and/or debit card. Additionally, the use of the Internet to process transactions between merchants and customers increasingly involves transmitting a customer's sensitive financial information over public networks.

Businesses have increasingly turned to the use of Internet transactions for the efficient purchase goods and services. Here, an individual associated with a business, such as an employee, may purchase goods and/or services on behalf of the business using a computing platform to communicate with merchants according to one or more Internet protocols. There is a need for processes enabling businesses to efficiently use such transactions while maintaining control over purchasing according to a policy.

### BRIEF DESCRIPTION OF THE FIGURES

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of a financial transaction system according to an embodiment;

FIG. 2 is a flow diagram illustrating a process for handling non-cash transactions between a merchant and a customer according to an embodiment;

FIG. 3 is a schematic diagram of a financial transaction system for paying merchant invoices according to an embodiment;

FIG. 4 is a flow diagram illustrating a process for paying merchant invoices according to an embodiment;

FIG. 5 is a schematic diagram of a financial transaction system for making off-line purchases according to an embodiment;

FIG. 6 is a flow diagram of a process to handle off-line purchases according to an embodiment;

FIG. 7A is a schematic diagram of a financial transaction system according to an embodiment;

FIG. 7B is a flow diagram of a process for processing an order from a customer according to an embodiment;

FIG. 8 is a schematic diagram of a computing platform according to an embodiment;

FIG. 9 is a schematic diagram of components within a computing platform according to an embodiment;

FIGS. 10A through 10D are diagrams illustrating information that may be transmitted between parties in a non-cash transaction according to an embodiment;

FIG. 11 is a purchase log of transactions according to an embodiment; and

FIG. 12 is a schematic diagram of an electronic shopping cart viewable in a graphical user interface (GUI) to enable a customer to specify purchase of goods and/or services from a merchant according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “terminating,” “downloading,” “identifying,” “initiating,” “querying,” “obtaining,” “hosting,” “maintaining,” “representing,” “modifying,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium. Further, unless specifically stated otherwise, process described herein, with reference to flow diagrams or otherwise, may also be executed and/or controlled, in whole or in part, by such a computing platform.

A “seller” as referred to herein relates to a party and/or entity that engages in transactions to provide goods and/or services in exchange for payment. In one embodiment, a seller may comprise a “merchant” that regularly engages in providing particular goods and/or services in exchange for payment as an on-going enterprise. Alternatively, a seller may comprise a private party which is willing to provide a good and/or service on a limited basis (e.g., a private party). However, these are merely examples of a seller and claimed subject matter is not limited in this respect.

A “customer” as referred to herein relates to a party and/or entity that engages in transactions with a seller to receive such goods and/or services in exchange for payment. For example, a seller may provide goods and/or services to one or more customers in exchange for payment from such customers in the form of cash payment, credit, account debit, barter exchange and/or the like. However, this is merely an example of how a seller and customer may engage in transactions for providing goods and/or services in exchange for payment, and claimed subject matter is not limited in these respects.

According to an embodiment, a seller may provide goods and/or services to a customer for non-cash payment. In particular examples, although claimed subject matter is not limited in these respects, such non-cash payment may be financed through credit that the customer has established with a merchant or a financial intermediary using, for example, a credit card. “Credit” refers to an amount of payment a merchant and/or financial intermediary is willing to receive from a customer as a non-cash payment. Such credit may quantify an allowable account balance which the customer promises to pay at a future date. Alternatively, such credit may comprise a cash balance that the customer has established with a merchant and/or a financial intermediary using, for example, a debit card. Credit may also comprise a combination of a cash balance and allowable debt. However, these are merely examples of how a seller and customer may engage in a non-cash transaction for providing goods and/or services, and claimed subject matter is not limited in these respects.

A customer may be associated with a “credit account” comprising information indicative of non-cash payment made on behalf of the customer and/or an ability to make non-cash payments for transactions in the future. For example, such a credit account may comprise an “account balance” representing a cumulative amount non-cash payment that has been made on behalf of the customer. Here, such an account balance may be maintained by a financial intermediary and/or merchant for payment and reconciliation by the customer in the future. Alternatively, such an account balance may represent a cumulative amount of non-cash payment that may be made on behalf of a customer in the future. Here, such an account balance may represent a cumulative amount of pre-payment and/or credit available for non-cash payment in the future. However, these are merely examples of a credit account and an account balance, and claimed subject matter is not limited in these respects.

According to an embodiment, although claimed subject matter is not limited in these respects, a credit account may be associated with identification information, such as an account number, which associates the credit account with one or more customers. Here, accordingly, a customer may place an order for the purchase of a good and/or service using non-cash payment by specifying a credit account number associating the customer with a credit account. Upon completion of such a transaction, an account balance of the associated credit account may be adjusted by an amount equal to the non-cash payment.

An entity, such as an enterprise, business and/or organization for example, may be associated with multiple individuals capable of independently initiating transactions to purchase goods and/or services from merchants on behalf of the entity. Such individuals may comprise, for example, employees, principles, agents and/or the like who are authorized to act as customers to initiate transactions according to a purchasing policy. In some embodiments, such customers may complete such transactions on behalf of such an entity using non-cash payment as illustrated above.

According to an embodiment, although claimed subject matter is not limited in this respect, an entity may authorize individuals to act as customers on behalf of the entity differently based, at least in part, on a purchasing policy. Here, for example, such a policy may authorize an owner and/or high level manager to make any purchase of a good and/or service on behalf of an entity, but limit authority of employee non-managers, for example, to purchase of only certain goods and/or services, or purchases from a limited set of merchants. However, this is merely an example of a policy that an entity may employ for controlling the purchasing of goods and/or services on behalf of the entity by multiple individuals and claimed subject matter is not limited in this respect. In another example, individuals comprising members of a family may be authorized as customers to make purchase on behalf of the family based upon their status in the family. Here, for example, a parent may be given unlimited authority while children may have limited purchasing authority to purchase only certain goods or make purchase only from specific merchants. However, these are merely examples of how a family purchasing policy may limit purchasing authority of children and claimed subject matter is not limited in this respect.

According to an embodiment, although claimed subject matter is not limited in these respects, individuals associated with an entity may be associated with a “privilege level” to characterize authority given to such individuals for the purchase of goods and/or services under a purchasing policy. For example, such an individual may be authorized to make a purchase of a good and/or service, and/or to make purchase from particular merchants based, at least in part, on a privilege level associated with the individual. Here, in a particular example, an individual associated with a “highest” privilege may be authorized to purchase any good and/or service on behalf of an entity and from any merchant. An individual associated with a “lower” privilege, on the other hand, may be limited to making purchases of particular products and/or services, and/or limited to making purchases from particular merchants. In an alternative embodiment, an individual associated with such a lower privilege level may be excluded from making purchases of particular products and/or services, and/or excluded from making purchases from certain merchants. It should be understood, however that these are merely examples of how a privilege level associated with an individual may affect how the individual may be authorized to purchase goods and/or services and claimed subject matter is not limited in these respects.

In another embodiment, a privilege level associated with an individual is not necessarily indicative as a “higher” or “lower” than another privilege level in a relative sense. For example, a privilege level may merely reflect authority associated with a particular individual that may be distinct from authority associated with one or more other individuals. In a particular example, provided for the purpose of illustration and not intended to limit claimed subject matter, a first individual associated with an entity may be associated with a first privilege level authorizing the first individual to purchase automobiles but not spare parts for automobiles. In contrast, a second individual associated with the entity may be associated with a second privilege level authorizing the second individual to purchase spare parts for automobiles but not automobiles. Accordingly, based on this description of first and second privilege levels, neither of the two privilege levels represent a privilege level that is necessarily “higher” than the other privilege level.

According to an embodiment, a privilege level associated with an individual may reflect an authority associated with a particular individual that is based on time of day, day of week, specific calendar days and/or the like. Here, for example, a particular privilege level may authorize certain purchases from an individual on Monday through Friday and/or during the hours of 8 am to 5 pm. In another example, a privilege level may authorize certain purchases by an individual for a specific calendar week. However, these are merely examples of how a privilege level associated with an individual may be based on time and claimed subject matter is not limited in this respect.

Embodiments described herein relate to, among other things, systems and method of processing financial transactions. As illustrated in U.S. Pat. No. 6,332,134 titled “Financial Transaction System,” one or more intermediaries may be involved in the processing of a non-cash transaction between a merchant and a customer in such a manner that the merchant does not need access to the customer's sensitive financial information and/or other personal information to complete the transaction. Here, a customer and a merchant may agree on terms of a proposed non-cash transaction to purchase a good and/or service to be financed through, for example, a credit card or debit card transaction. The customer may then forward information regarding the transaction to a financial intermediary (e.g., a credit card company). The financial intermediary may then forward a “payment notification” to the merchant to enable completion of the non-cash transaction. Here, such a payment notification may comprise, among other things, information expressing an intent and/or promise to make payment in exchange for a good and/or service. The merchant may then provide the goods and/or services, and the financial intermediary and the customer may settle accounts following the purchase.

According to a particular embodiment, a payment notification from a financial intermediary may comprise information expressing an intent and/or promise to make payment in exchange for a good and/or service to be provided in such a non-cash transaction. In one example, such a payment notification may create a binding agreement between and/or among parties for providing a good and/or service in exchange for payment. In other examples, however, such payment notification need not necessarily create a binding agreement.

According to an embodiment, although claimed subject matter is not limited in these respects, “completion” or “termination” of a financial transaction may occur upon any one of several events associated with such completion or termination of a financial transaction. In one embodiment, completion may occur upon tendering a good and/or service to a customer, payment of funds to a merchant or a confirmation (or promise) to a merchant that payment for a good and/or service is forthcoming. However, these are merely examples of events that may be used to define a completion of a transaction and claimed subject matter is not limited in these respects. In one embodiment, termination of a transaction may occur upon an event and/or condition that prevents completion of a transaction. For example, such a termination of a transaction may occur upon an event and/or condition that prevents payment to a merchant, notice of payment and/or delivery of goods and/or services. However, this is merely an example of a termination of a transaction and claimed subject matter is not limited in this respect.

According to particular embodiments described herein, financial transactions may be facilitated by transmitting information over data networks using any one of several communication protocols such as, for example, the Internet protocol and related communication protocols. For convenience, references to the Internet are used herein, but embodiments are equally applicable to any type of data network, and claimed subject matter is not limited in this respect. According to particular embodiments, although claimed subject matter is not limited in this respect, a transaction between a customer and merchant may be completed without transmission of a customer's sensitive information, such as credit card information and/or other personal financial information, over the Internet. Accordingly, such sensitive information need not leave the possession of the customer to complete the transaction. Also, embodiments described herein may be suitable for use in any country and with any currency, since embodiments of the system allow financial institutions to effectuate currency exchange based on any existing exchange rates.

According to an embodiment, participants in a financial transaction system may comprise a seller, customer, and/or one or more financial intermediaries. While the following discussion illustrates interactions among such a seller, customer and a financial intermediary as a merchant, cardholder and card company, respectively, these are merely examples provided for illustration of a particular embodiment of a financial transaction system. Other financial transaction systems may facilitate interactions involving a customer that is not a card holder, or a financial intermediary that is not a card company and/or a seller that is not a merchant, and claimed subject matter is not limited in this respect.

In transaction illustrated below, a merchant may comprise any party capable of providing a good and/or service to a customer as part of a credit and/or non-cash transaction. In one particular embodiment, although claimed subject matter is not limited in this respect, a merchant may provide and/or dispense cash to a customer in a transaction that is financed by a financial intermediary. In one example, such a merchant may operate an automatic teller machine (ATM). Here, the good and/or service being purchased by a customer is cash. However, this is merely an example embodiment and claimed subject matter is not limited in this respect.

In particular embodiments described herein, a credit account may be maintained on behalf of an entity for the purchase of goods and/or services on behalf of the entity by multiple customers. Here, for example, non-cash transactions for the purchase of goods and/or services by multiple customers and/or individuals acting on behalf of the entity may be paid via a single credit account established and/or maintained on behalf of the entity.

According to an embodiment, a financial intermediary may provide credit to a customer. For example, the financial intermediary may comprise a credit financial intermediary, a bank, a credit union, or other financial institution capable of facilitating credit card transactions. Such credit provided to a customer can be derived from any type of account, such as a credit card account, debit card account, a bank account, savings account, checking account or brokerage account. However, these are merely examples of how credit may be provided to a customer using particular types of accounts and claimed subject matter is not limited in these respects. Therefore, virtually any type of financial institution and/or financial intermediary can provide credit to the customer based on any type of account without deviating from claimed subject matter.

A customer may establish an account with a financial intermediary to obtain credit which may be use to make financial transactions including, for example, purchase of goods and/or services, or payment of invoices. Such an account established by a customer may be associated with confidential personal information such as, for example, an account number and credit limit. A financial transaction system may eliminate any need for the transmission of such confidential information outside the control of the customer. A merchant may participate in a financial transaction system by providing information about items to be purchased and by agreeing to be paid by the financial intermediary on behalf of the customer.

In an alternative embodiment, an entity may establish credit directly with a merchant, and without the use of a financial intermediary, to enable multiple individuals to purchase goods and/or services from the merchant. For example, an entity may establish a credit account with the merchant enabling multiple customers to purchase goods and/or services from the merchant on behalf of the entity using non-cash transactions. A merchant may then receive and process purchase orders from such customers without further interaction with a financial intermediary.

According to an embodiment, and as illustrated below with specific examples, a customer merchant and/or financial intermediary may be associated with a communication devices and/or computing platforms capable of communicating with one another over a data communication network. In a particular example, although claimed subject matter is not limited in this respect, a customer may participate in non-cash transactions with a merchant by using a personal computer, cell phone, personal digital assistant, two-way pager and/or interactive television that receives user inputs from a remote control. However, these are merely examples devices that may enable a customer to participate in a non-cash transaction according to a particular embodiment and claimed subject matter is not limited in this respect.

According to an embodiment, a customer may register with a financial transaction system by contacting a financial intermediary and requesting that one or more of the customer's accounts available for use in the financial transaction system. During such customer registration, a customer may receive software to install on the customer's computing platform. Such software may contain, for example, code and/or information that can be recognized by a registered merchant's website that allows a purchase using the financial transaction system. Such software may contain a changeable user password, a customer ID, a “Sales Log” database, dialing software, instructions, off-line catalog sites, and any miscellaneous promotions and/or data. A customer may load such software on his or her computing platform and follow step by step instructions culminating in clicking on a “Register Now” button on a graphical user interface (GUI), for example. Executing the software, the computing platform may then contact the financial intermediary by, for example, dialing the financial intermediary's toll free number (e.g., using the computing platform's phone modem) or through other on-line means (e.g., Internet protocol over a broadband modem). Following such contact of the financial intermediary, a registration process may be conducted. Here, according to a particular embodiment, a customer's ID and password may be checked against the financial intermediary's records. At registration, a different password may be chosen. For example, in one particular embodiment, multiple customer IDs and passwords can be assigned to the same credit card and/or account number.

As illustrated above, an entity may be associated with multiple individuals that may act as customers to purchase goods and/or services on behalf of the entity. According to a particular embodiment, although claimed subject matter is not limited in this respect, a single credit account may be established to facilitate payment for non-cash transactions for goods and/or services on behalf of an entity by multiple individuals and/or customers. In one example, such a credit account may be associated with a single account number. In another example, an entity may establish a single credit account having multiple account numbers to be used by associated multiple customers in purchasing goods and/or services on behalf of the entity.

In a particular embodiment, although claimed subject matter is not limited in this respect, multiple account numbers associated with a credit account may comprise a single account number comprising a first field, comprising a main account number, which is concatenated with a second field, associated with particular individuals authorized to make purchases using the credit account. To illustrate, such an account number may have the format “XXXXXX-YYY” where “XXXXXX” comprises numbers in a first field associated with the main account and “YYY” comprises a second field comprising a sub-account number. Such a sub-account number may be associated with a customer and/or individual authorized to purchase goods and/or services with non-cash payment using a credit account. In one particular embodiment, such a main account number may be associated with an account established for non-cash purchases on behalf of an entity and the sub-account number may be associated with one or more customers and/or individuals authorized to make purchases on behalf of the entity using the credit account.

In one particular embodiment, although claimed subject matter is not limited in these respects a sub-account number, as illustrated above, may be indicative of a privilege level associated with an individual presenting the sub-account number (e.g., in a purchase request) in making purchases using the main account. In one embodiment, such a sub-account number may be associated with extrinsic information, such as information stored in a look up table, to determine a privilege level associated with the sub-account number. In one example, such a sub-account number may be uniquely associated with an individual such as a unique employee number associated with an employee in and enterprise. In this particular example, extrinsic information associates such unique employee numbers to one or more privilege levels. In another example, such a sub-account number may be associated with class of individuals within an organization such as officers, managers, employees, members of a subdivision of an organization such as a department and/or the like, where extrinsic information associates such class distinctions with privilege levels. In yet another example, such a sub-account number may be directly related to a privilege level, independently of other extrinsic information. It should nevertheless be understood, however, that these are merely examples of how a sub-account number may comprise information that is indicative of a privilege level and claimed subject matter is not limited in these respects.

An Order Verification Reply Target (OVRT) may be provided by the customer comprising information enabling a financial intermediary to address messages to the customer containing order confirmations or other information. Such an OVRT may comprise, for example, a telephone number to receive voice and/or facsimile communications, an e-mail address, Universal Resource Locator (URL), domain name and/or the like to which real-time communications may be addressed. It should be understood, however, that these are merely examples of information that may be used for addressing messages regarding a transaction to a customer and claimed subject matter is not limited in these respects. It is also possible for a customer to register by voice over the telephone, fax or mail, however, installing computer software on customer's computing platform allows the customer to use the financial transaction system when making purchases over data networks, like the Internet.

A merchant may register with the financial intermediary to use a financial transaction system to become authorized to accept payment for providing goods and/or services in transactions with customers. For example, the financial intermediary and merchant may agree to use an Automatic Clearing House (ACH) to allow bank-to-bank transmission of funds to pay for merchant goods. Thus, a merchant's invoice may be satisfied when the financial intermediary transfers funds to the ACH and then notifies the merchant of the transfer.

According to an embodiment, a merchant may also register for participation in a financial transaction system by installing software to a computing platform for recognizing consumers browsing a website using software installed on the consumers' computing platform identifying (as illustrated below) such customers as being registered to the financial transaction system. Upon such registration, a merchant may receive a database enabling processing of non-Internet orders from consumers using off-line catalogs. Also, such a merchant may also receive unique identifier (ID) that is contained within the computer software installed to the merchant's computing platform. It should be understood, however, that these are merely examples of software that may be installed on a merchant's computing platform, and claimed subject matter is not limited in these respects.

As illustrated above, a customer may provide an OVRT to enable a financial intermediary to notify a customer of the status of orders and/or other information. Here, for example, a financial intermediary may notify a customer of a completion or termination of a transaction, and any problems that may have arisen in the course of the transaction, by associating the customer its OVRT. Such notification may be in the form of an automated reply via email or other Internet protocol, fax and/or a voice message, for example. A merchant may also be associated with an OVRT to the financial intermediary to receive information relating to customer purchases. In one particular embodiment, although claimed subject matter is not limited in these respects, an OVRT may be associated with an Internet Protocol (IP) address and/or Internet domain name. However, these are merely examples of how an OVRT may be implemented and claimed subject matter is not limited in these respects.

According to an embodiment, although claimed subject matter is not limited in these respects, an entity may be associated with multiple OVRTs associated with multiple individuals and/or customers authorized to purchase goods and/or services on behalf of the entity. Accordingly, notifications regarding status of transactions initiated by a particular one of such individuals and/or customers may be addressed according to the OVRT associated with the particular individual and/or customer. To facilitate maintaining records for transactions on a single credit account initiate by more than one individual and/or customer, according to a particular embodiment, an OVRT may be provided for a point for receiving purchased goods and/or services.

During customer registration, a shipping address for the customer may be provided. Such a shipping address may indicate where items that are purchased by the customer are to be shipped. This can be different from a customer's billing address. The billing address may indicate where the financial intermediary should send bills relating to the customer's credit account. According to an embodiment, a financial transaction system may allow, by use of authentication using a password and User ID for example, one or more alternative addresses to be used for specific purchases. This may overcome a problem of having a billing address that is different from the shipping address. For example, a P.O. Box may be used, or some other temporary address so that, for instance, a customer may purchase airline tickets while traveling or when making a purchase to send to another address as a gift.

According to an embodiment, a history of purchases made by a customer using a financial transaction system may be maintained in a database stored on a computing platform operated by the customer. This may allow such a customer the convenience of determining information about what has been purchased, vender, price, etc. Also, the data may be maintained in a format (e.g., data fields separated by tab or comma) that may be exportable to record keeping software such as Quicken, Excel, FileMaker Pro or any program that accepts data in such a format. In one particular embodiment, although claimed subject matter is not limited in this respect, such data may comprise a history of transactions of multiple customers and/or individuals making purchases using the customer's account.

As discussed above, customers and merchants may register to obtain an ID and password to be used in participating in the financial transaction system. Software installed on a customer's computing platform (and/or a computing platform operated by a individual and/or customer making purchases using customer's account) may operate in conjunction with well known browser programs to allow browsing the Internet and make purchases using the financial transaction system. Such installed software may include one or more of the following modules and/or items of information:

plugins covering typical operating systems and browsers;

registration routine (as illustrated above);

routine for maintaining database logging purchases for the customer's use;

instructions for registration;

dialing string software for initial registration to a direct toll free line;

IP address, URL and/or domain name for use in contacting financial intermediary for registration;

offline website/catalogs featuring financial intermediary merchants;

credit card application for the financial intermediary;

applications to register with shipping companies; and

browser(s) which is adapted to dial direct any of the selected merchants via a toll free offline number.

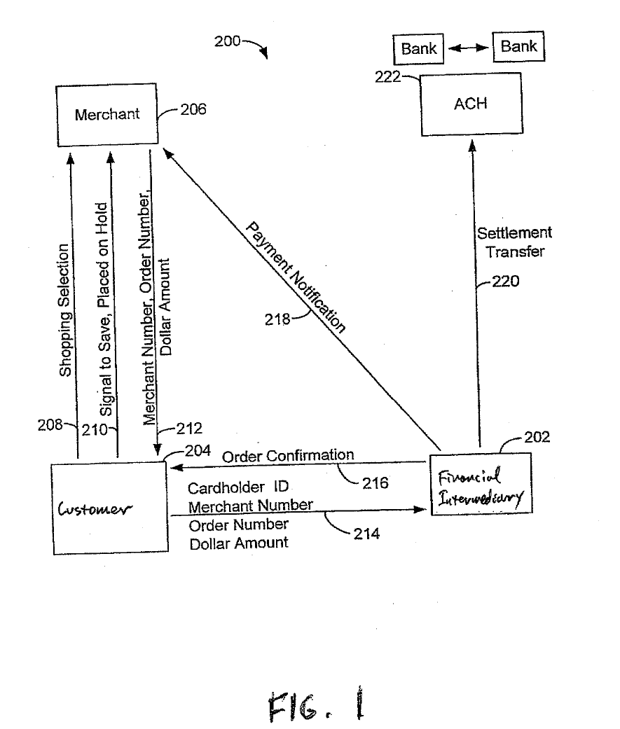

FIGS. 1 through 6 show a customer as a single entity capable of initiating transactions using a financial transaction system. In some embodiments, as illustrated above, multiple individuals and/or customers may be capable of independently initiating such transactions using a credit account established for a single entity. For simplicity, for such embodiments, it should be understood that while a customer as depicted in FIGS. 1-6 may represent merely one individual and/or customer capable of initiating transactions using a credit account established for an entity, multiple individuals and/or customers may be capable of independently initiating transactions with a merchant (e.g., using a computing platform or other device capable of communicating with a merchant and/or financial intermediary). Accordingly, it should be understood that the actions described below in connection with a customer may be applicable to individual ones of multiple individuals and/or customers initiating non-cash transactions for the purchase of goods and/or services using a credit account established on behalf of a single entity and/or customer. It should also be understood that references to a “customer's computing platform,” “computing platform operated by customer” and/or the like may refer to a computing platform being operated by an individual and/or customer among multiple individuals and/or customers capable of initiating non-cash transactions using the credit account established on behalf of a customer.

FIG. 1 is a schematic diagram of a financial transaction system 200 according to an embodiment. In a particular embodiment, although claimed subject matter is not limited in this respect, a financial intermediary 202, merchant 206 and customer 204 may operate and/or control computing platforms that are capable of communicating with one another over a communication network such as the Internet, for example. Accordingly, as referred to herein, the term “message” may relate to the transmission of information from a source to a destination using any one of several mediums such as, for example, a communication network such as the Internet and other IP infrastructure (e.g., email, HTTP, XML, etc.), dialup connection, facsimile transmission, person-to-person phone conversation, just to name a few.

As discussed above, credit financial intermediary 202 may provide software to a customer 204 to be loaded to customer's computing platform for implementing features of a financial transaction system. This may allow customer 204 to conduct financial transactions over the Internet or other data network, for example. Financial intermediary 202 may also authorize a subscribed merchant 206 to utilize the financial transaction system and issue software to merchant 206 for use in conjunction with merchant's interface to financial transaction system 200 including, for example, a website. Here, merchant 206 may agree to accept payment from financial intermediary 202 via an ACH 222, which may perform bank to bank transfers for example. Once the software is installed on computing platforms of both customer 204 and merchant 206, a financial transaction may be conducted as illustrated above.

The description below illustrates interactions between a customer's computing platform and a merchant's computing platform as inputs provided by the customer to a GUI on customer's computing platform which are received at a website operated and/or controlled by the merchant according to an HTTP protocol in a particular embodiment. Alternatively, however, computing platforms operated and/or controlled by a merchant and a customer may employ any one of several techniques to communicate such as, for example, dial-up modem-to-modem communication over phone lines, a Web service, email and/or other protocols supported by the Internet protocol. It should be understood, however, that these are merely examples, of how a customer's computing platform may communicate with a merchant's computing platform and claimed subject matter is not limited in this respect.

In particular examples, although claimed subject matter is not limited in these respects, a Web service as indicated herein may employ standard communication protocols to transmit data objects among component applications over an Internet protocol such as, for example, HTTP, HTTPS, XML, SOAP, WSDL and/or UDDI standards. Here, XML may be used to tag data objects, SOAP may be used to transfer data objects, WSDL may be used to describe available services and UDDI may be used to list available services. However, these are merely examples of protocols that may enable a Web service and claimed subject matter is not limited in these respects.

As illustrated above according to particular embodiments, a plurality of individuals and/or customers may initiate non-cash transactions with merchant 206 for the purchase of goods and/or services under a credit account established with financial intermediary 202 on behalf of customer 204. Also, as illustrated above according to particular embodiments, such an individual and/or customer may be associated with a privilege level that may determine, at least in part, whether the individual and/or customer is authorized to complete such transactions. As illustrated below according to particular embodiments, a transaction between a customer acting on behalf of customer 204 and merchant 206 may be selectively terminated based, at least in part, on a privilege level associated with the customer.

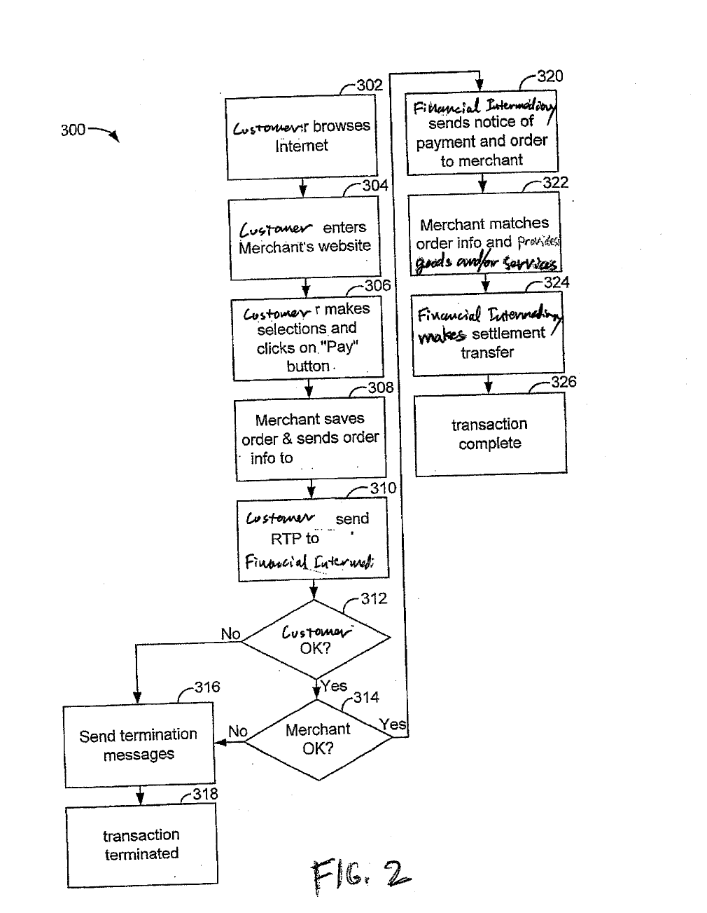

FIG. 2 is a flow diagram illustrating a process 300 of conducting a financial transaction using financial transaction system 200, for example, to enable secure financial transactions among customer 204, merchant 206 and financial intermediary 202. At block 302, a customer may browse the Internet using a browser program. In one embodiment, as pointed out above, software loaded to such a customer's computing platform may operate as a plug-in for such a browser.

At block 304, a customer may communicate with a merchant's website, which may be in communication with software installed on a merchant's computing platform and provided by the financial transaction system as illustrated above. Here, the merchant's website may recognize the customer's browser software, and thus identify the customer as a member of and/or participant in the financial transaction system. For example, in one embodiment, the customer's browser may transmit special codes and/or information upon entering the merchant's website. Such codes and/or information may be interpreted by the software installed on the merchant's system to determine that the customer is registered with the financial transaction system. In another embodiment, the merchant's computing platform may transmit special codes and/or information to the customer's computing platform, which can be interpreted at the customer's computing platform. The customer's computing platform may then respond to the merchant's system, resulting in both computing platforms acknowledging membership in the financial transaction system.

At block 306, a customer may select one or more goods and/or services or services for purchase from the merchant's website. In a particular example, this is shown at path 208 in FIG. 1. For example, the website may provide a virtual shopping cart to maintain a record of customer selections. At some point, the customer may desire to purchase the items in the shopping cart, and clicks on a “button” on a GUI, for example, which may read, “pay by financial transaction system.” This is shown at path 210.

At block 308, after the customer clicks the “pay by financial transaction system” button, which is signaled to the merchant's computing platform, the merchant's computing platform may save customer's order in a merchant database. The merchant's computing platform may then create a purchase order containing the merchant's ID, a unique order number for the purchase, a dollar amount for the purchase, and identification data such as the merchant's email address, domain name, etc. The purchase order may then be transmitted to the customer's computing platform, as shown at path 212, and stored in a database on the customer's computing platform. In essence, though not necessarily-in all embodiments, the purchase order may act as merchant's offer to sell the selected items to customer.

At block 310, in a particular embodiment, a customer's browser may “tickle” a merchant Website to keep an Internet session active. In the meantime, customer's browser may transmit a request to pay (RTP) to the financial intermediary's system in and RTP message 214. RTP message 214 may include the purchase order data from the merchant and the customer's unique ID and password. According to an embodiment, RTP message 214 may include an account number as a part of, or in addition to, customer's unique ID. As illustrated above, such an account number may be associated with a credit account established for use in the purchase of goods and/or services on behalf of customer 204. Also as illustrated above in connection with a particular embodiment, one or more individuals and/or customers may purchase goods and/or services using such a credit account.

At blocks 312 and 314, the RTP and the purchase order may be processed by financial intermediary 202. Here, a computing platform may perform two tests. A first test, at block 312, may determine whether customer is allowed to make the requested purchase. For example, it is determined whether the customer has enough credit available to pay for the selected items. A second test, at block 314, may determine whether the merchant is allowed to participate in this transaction. For example, is the merchant a registered merchant in good standing.

At block 316, if either test fails, the financial transaction system may reply to the predetermined OVRT addresses with an appropriate message for both merchant and customer. For example, one message may go to the customer to state that there is not enough credit available to make the requested purchase. A second message may go to the merchant to state that the customer is unable to complete the transaction. The merchant may also receive a message indicating that the transaction was terminated since the merchant is not a member of the financial transaction system. The merchant's OVRT may be provided during merchant registration or included in the purchase order information sent to the financial intermediary. Once the messages are sent, the transaction is terminated as shown at block 318.

At block 320, if both tests at blocks 312 and 314 pass, the financial intermediary system replies to the predetermined OVRT addresses with an appropriate message to both the customer and the merchant. A message 218 to customer 204 may comprise an order confirmation number or other indication that the order is to be placed. A message to merchant 206 may include a unique order number and a pre-registered shipping address or an authorized alternate shipping address. The financial intermediary may also notify the merchant that payment has been made to ACH 22 used to transfer funds between financial intermediary 202 and the merchant 206.

As illustrated above according to particular embodiments, a transaction initiated by an individual and/or customer to purchase goods and/or services using credit established on behalf of an entity may be allowed to complete based, at least in part, on a privilege level associated with the individual and/or customer. In the financial transaction 200 of FIG. 1, for example, diamond 312 may determine whether a transactions it to terminate or allowed to complete based, at least in part, on a privilege level associated with customer 204 using one or more of the techniques illustrated above. As described above, RTP message 214 may comprise an account number that is to be used in accessing a credit account established on behalf of customer 204. Also as illustrated above according to a particular embodiment, multiple individuals and/or customers (e.g., acting on behalf of customer 204) may be authorized to purchase goods and/or services on behalf of an entity in non-cash transactions using such a credit account. Accordingly, in a particular embodiment, diamond 312 may selectively enable a transaction to complete or terminate a transaction initiated by one of a plurality of customers and/or individuals based, at least in part, on a privilege level indicated in a credit account number included as part of RTP message 214. As illustrated above with respect to a particular embodiment, such a privilege level may be indicated in a particular field of an account number that is concatenated with a main account number. However, this is merely an example of how a financial intermediary may determine a privilege level associated with an individual and/or customer, and claimed subject matter is not limited in these respects.

According to an embodiment, diamond 312 may determine whether an individual and/or customer has a requisite privilege level to purchase a good and/or service set forth in RTP message 214. It should be understood, however, that in particular embodiments diamond 312 may consider such a privilege level as one factor among multiple factors in determining whether a transaction initiated by a customer and/or individual is to be terminated or allowed to complete. As illustrated below in particular embodiments, other such factors may include particular merchant from which a good and/or service is being purchased, transaction price, competitive bidding requirements, character of the good and/or service, and/or preferred vendor requirements, just to name a few.

Depending on a privilege level associated with an individual and/or customer, according to a particular embodiment, diamond 312 may limit purchase of certain kinds of goods and/or services by the individual and/or customer to certain merchants and not allow such purchase from other merchants. For example, depending on a privilege level associated with an individual and/or customer, diamond 3 2 may impose additional requirements in allowing a transaction to complete based, at least in part, on metadata associated with merchant 206. In alternative embodiments, however, diamond 314 may selectively terminate a transaction or allow a transaction to complete based, at least in part, on such metadata associated with merchant 206, irrespective of any privilege level associated with an individual and/or customer. In one embodiment, although claimed subject matter is not limited in this respect, metadata associated with merchant 206 may include, for example, information representative and/or indicative of products and/or services offered by merchant 206, location of merchant 206 (e.g., state/country of incorporation, principle place of business and/or the like), solvency of merchant 206, rating of merchant 206 by customers, uniqueness of product and/or service being offered, commoditization of product and/or service being offered, criminal history, a number of disputes involving merchant 206 and customers and/or financial intermediary 206, any ties to criminal organizations and/or to terrorists organizations, to name a few. Such metadata may be obtained from, for example, publicly available information such as information from government databases (e.g., filings with the Security and Exchange Commission, tax records, and/or the like). Other such sources may provide proprietary and/or paid services. Such other sources may include, for example, credit agencies, a trusted source that provides information regarding on-line merchants, to name a few. Additional information regarding such metadata associated with a merchant may be found in U.S. patent application Ser. No. [Atty Docket No. 012.P33003], titled “Termination of Transactions” and assigned to the assignee of claimed subject matter.

In another embodiment, although claimed subject matter is not limited in this respect, diamond 312 may impose a requirement that a customer and/or individual having a certain privilege level purchase a good and/or service specified in RTP 214 only from certain preferred vendors while a customer and/or individual having a different privilege is not subject to such a preferred vendor requirement. Here, for example, in implementing such a preferred vendor requirement, diamond 312 may selectively terminate or allow a transaction to complete based, at least in part, on whether merchant 206 is such a preferred vendor. In alternative embodiments, block 314 may implement such a preferred vendor requirement irrespective of any privilege level associated with a customer and/or individual initiating a transaction. In one particular embodiment, although claimed subject matter is not limited in this respect, a preferred vendor requirement may be relaxed if a good and/or service set forth in an RTP message is not available from a preferred vendor (e.g., out of stock, not available within a predefined timeframe and/or the like).

Depending on a privilege level associated with an individual and/or customer, according to a particular embodiment, diamond 312 may limit purchase of certain kinds of goods and/or services by the individual and/or customer based, at least in part, on a purchase price associated with such goods and/or services. For example, depending on a privilege level associated with an individual and/or customer, diamond 312 may impose additional requirements in determining whether to allow a transaction to complete or terminate a transaction based, at least in part, on a purchase price set forth in RTP message 214. In a particular embodiment, depending upon a particular privilege level associated with an individual and/or customer, block 312 may selectively allow a transaction to complete if a purchase price set forth in RTP message 214 does not exceed an approximated purchase for the subject good and/or service by a predetermined dollar amount and/or percentage. Such an approximated purchase price may include, for example, an average sales price, median sales price, historical purchase price from a particular vendor, just to name a few examples. In alternative embodiments, process 300 may determine whether to allow a transaction to complete or terminate a transaction based, at least in part, on a purchase price set forth in RTP message 214 irrespective of any privilege level associated with an individual and/or customer initiating a transaction.

Depending on a privilege level associated with an individual and/or customer, according to a particular embodiment, diamond 312 may require the individual and/or customer to obtain competitive bids as a precondition to allowing a transaction to complete. Here, for example, RTP message 214 may include information indicating that customer 204 has obtained a certain number of bids from merchants and information descriptive of such bids. Diamond 312 may then selectively determine whether RTP message 214 meets a competitive bidding requirement by, for example, determining whether a bid from merchant 206 does not comprise a highest bid, comprises a lowest bid and/or the like. However, this is merely an example determining whether an order meets a competitive bidding requirement and claimed subject matter is not limited in these respects. In alternative embodiments, diamond 314 may impose a competitive bidding requirement to determine whether a transaction is to complete irrespective of a privilege level associated with an individual and/or customer initiating the transaction. For example, diamond 314 may determine whether to terminate a transaction or allow a transaction to complete based, at least in part, on a competitive bidding requirement set forth above irrespective of any privilege level associated with a customer and/or individual.

Depending on a privilege associated with an individual and/or customer, according to a particular embodiment, diamond 312 may selectively terminate or allow completion of a purchase of a good from merchant 206 based, at least in part, on whether the good is a depreciable good such as, for example, office furniture and computer equipment. It should be understood, however, that qualification of goods as being depreciable may vary from industry to industry and claimed subject matter is not limited in this respect. In one embodiment, a purchasing policy of an organization may dictate not purchasing certain depreciable goods until a subsequent time period (e.g., next quarter or year). Here, such a purchasing policy may dictate that a new computer be leased instead of bought where such a lease may be “bought out” later, for example. In alternative embodiments, however, irrespective of a privilege level associated with an individual and/or customer, process 300 may selectively terminate a transaction initiated by the individual and/or customer or allow such a transaction to complete based, at least in part, on whether goods in question are depreciable.

At block 322, merchant 206 may match order information contained in a received OVRT with order information contained in a database maintained by merchant 206. If the information matches, merchant 206 may ship the order to a specified address. In an alternative embodiment, the merchant may not have access to address information associated with a destination of a customer's purchased goods. Here, a shipping party (not shown) may merely receive goods from the merchant with order information. The shipping party may then associated the order information with location to deliver the purchased goods.

At block 324, financial intermediary 202 may collect payment from customer 204 and forward payment to merchant 206 via a settlement transfer message 220 to ACH 222. In alternative embodiment, financial intermediary 202 may aggregate transactions completed by multiple customers and/or individuals authorized for settlement with ACH 222. For example, financial intermediary 202 may maintain an account balance for non-cash transactions completed using a credit account established on behalf of customer 204 or associated entity. In one particular embodiment, although claimed subject matter is not limited in this respect, once the settlement transfer is made, the transaction is complete as shown at block 326.

As a result of performing a financial transaction in accordance with the method 300, a customer's credit card number or other personal information need not be transmitted over a computer network. This prevents theft of customer's personal information. An additional level of security is provided since the merchant never has access to the credit card number or other personal information. Therefore, corruption or lack of security at the merchant's site will have no effect on the security of the customer's personal information.

Transfer of funds from the financial intermediary to a merchant may be performed using any one of several methods of transferring funds. In the above embodiment, such a transfer may occur using an ACH. Since such transfer of funds is secondary, claimed subject matter is not limited in this respect as it is possible to transfer funds in other ways by, for example, wiring funds directly to a merchant's account.

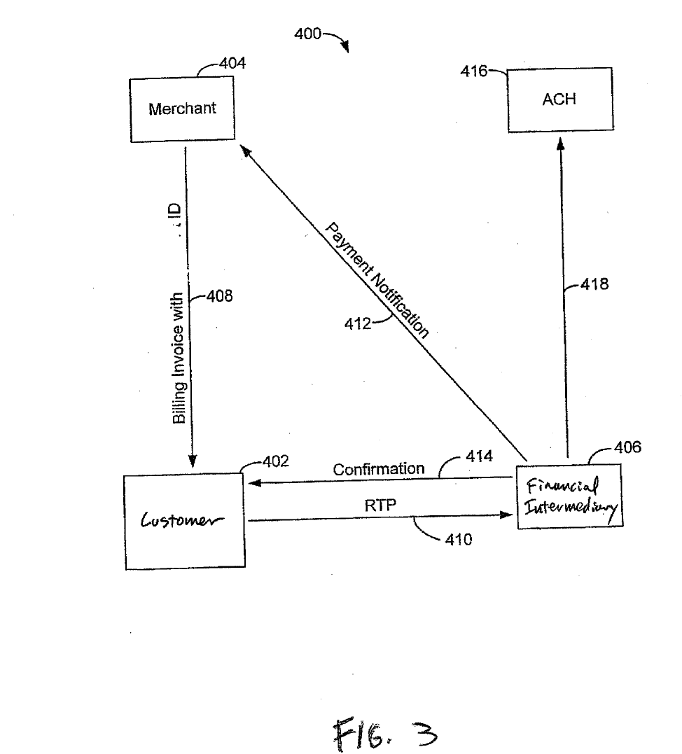

In another embodiment, although claimed subject matter is not limited in this respect, an invoice paying system is provided, wherein a customer can make payments to merchants and/or service providers and/or other customers registered with a financial transaction system. FIG. 3 shows an invoice paying system 400 (or bill paying system) for paying invoices for goods and/or services in accordance with an embodiment. System 400 may allow a customer 402 to pay an invoice from a merchant 404 via a financial intermediary 406. As illustrated above in financial transaction system 200 with reference to FIG. 1, financial intermediary 406 may selectively terminate such transactions or allow such transactions to complete based, at least in part, on a privilege level associated with a customer and/or individual initiating such transactions.

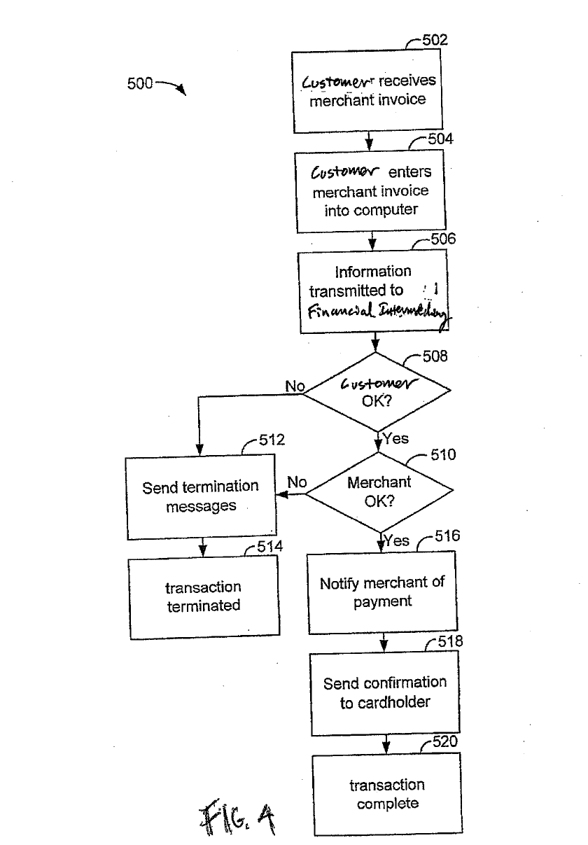

FIG. 4 is a flow diagram illustrating a process 500 for conducting a financial transaction for use with an invoice paying system such as invoice paying system 400 shown in FIG. 3, for example. Here, a merchant and customer may be registered with invoice paying system 400 as illustrated above.

At block 502, customer 402 may receive an invoice for goods and/or services from merchant 404. Such an invoice may be received via electronic means, such as email, Web service or as a delivered hardcopy and may contain merchant 404's ID number along with other relevant billing information. This is shown at message 408, for example. As illustrated above with reference to FIGS. 1 and 2 above according to particular embodiments, one or more customers and/or individuals may be authorized to forward an RTP message 410 to financial intermediary 406 for payment from a credit account established on behalf of customer 402.

At block 504, customer 402 may enter a merchant's ID information and billing information into his or her own computing platform having software for the financial transaction system installed thereon as discussed above. At block 506, customer 402 may transmit this information to financial intermediary 406 along with an RTP 410, for example.

At diamond 508, financial intermediary 406 may verify that customer 402 has sufficient credit available to pay the merchant invoice. At diamond 510, financial intermediary 406 may verify that merchant 404 is registered with financial transaction system 400 and is eligible to receive payments accordingly. As illustrated above according to the particular embodiment of FIG. 2, financial intermediary 406 may selectively terminate the transaction based, at least in part, on a privilege level associated with a particular customer and/or individual forwarding RTP 410 to financial intermediary 406. As illustrated above in FIG. 2 with reference to diamond 312, diamond 508 may selectively terminate a payment transaction or allow such a payment transaction to complete based, at least in part on a privilege associated with the particular customer and/or individual.

At block 512, if the checks performed at diamonds 508 and 510 fail, then a message may be sent to the customer indicating that the invoice cannot be paid by the financial transaction system. The transaction may then terminated as shown at block 514. A message need not be sent to merchant 404 since merchant 404 may not even be aware that customer 402 is attempting to pay the invoice via the financial transaction system.

At block 516, if the checks at diamonds 508 and 510 pass, financial intermediary 406 may notify merchant 404 that payment has been made on behalf of customer 402 for the invoice amount through message 412. Financial intermediary 406 may then transfer funds to the ACH 416 agreed to by merchant 404 and financial intermediary 406 via message 418.

At block 518, financial intermediary 406 may transmit a confirmation message 414 to customer 402 indicating that merchant 404 has been paid. At block 520, the transaction may be completed and the customer can record in a payment log that the invoice has been paid. Merchant 404 may then send the purchased items to customer 420 which may include an account statement for customer 402's records.

In business situations, an invoice paying system may allow a customer to make repeat orders or orders as needed, rather than having to cancel a standing automatic recurring system order. Professional services that don't have a website, for example, but wish to take credit card payments, can do so using the invoice paying system described herein. For example, if a customer obtains a service provider's ID number associated with the financial transaction system and invoice information from a bill mailed to the customer, the customer can still arrange for payments to be made via the financial transaction system with notification sent to the merchant via telephone, e-mail, a Web service, mail or fax systems.

According to an embodiment, although claimed subject matter is not limited in this respect, a financial transaction system may provide for purchasing goods and/or services from catalogs published by merchants. Such catalogs may be in the form of hardcopy, electronically downloaded merchant catalogs or web pages. Thus, a purchaser can view the catalog information in an off-line mode, i.e. when not connected to a merchant's website, and purchase selected goods or services. When downloaded as web pages, the catalogs may be fully functional and operate in the same manner as if the customer was connected on-line to the merchant's website.

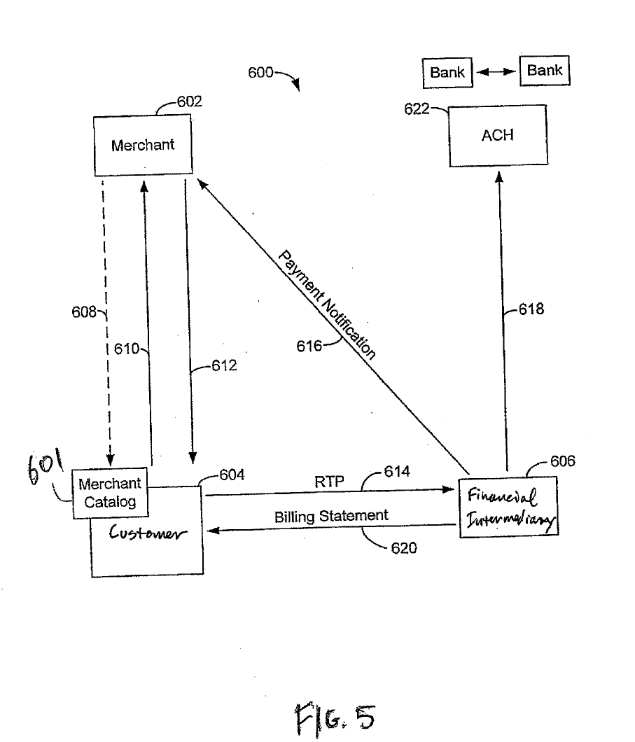

FIG. 5 is a schematic diagram of a financial transaction system 600 for purchasing goods and services off-line according to an embodiment. A merchant 602 may provide catalog information 601 about available goods or services to a customer 604 (or purchaser). Customer 604 may make purchases from the catalog 601 using a financial transaction system provided by financial intermediary 606, for example. An ACH 622 may make bank to bank transfers allowing financial intermediary 606 to transfer funds to merchant 602 on behalf of customer 604. As illustrated above in financial transaction system 200 with reference to FIG. 1 and in invoice paying system 400 with reference to FIG. 3, financial intermediary 606 may selectively terminate such transactions or allow such transactions to complete based, at least in part, on a privilege level associated with a customer and/or individual initiating such transactions.

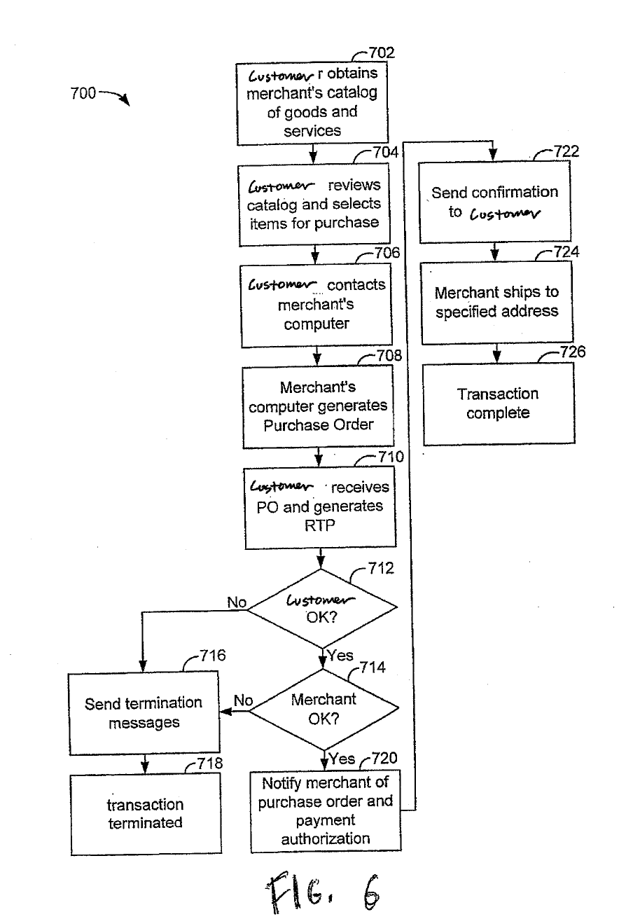

FIG. 6 is a flow diagram illustrating a process 700 for conducting a financial transaction using the financial transaction system of FIG. 5, for example. At block 702, customer 604 may receive a catalog 601 from merchant 602, as shown by communication 608. Customer 604 may obtain catalog 601 in any one of several forms such as, for example, a hardcopy catalog to the customer via regular mail, other mail delivery, facsimile service and/or the like. Merchant 602 may also transmit a softcopy of catalog 601 to customer 604's computing platform via email and/or other electronic transmission means. It some embodiments, customer 604 may communicate with a website being operated by merchant 602 to selectably download catalog 601 from the merchant's website to the customer 604's computing platform for later viewing. Catalog 601 may also comprise an off-line version of a website operated by merchant 602. It should be understood, however, that these are merely examples of how a customer may obtain a version of a catalog and claimed subject matter is not limited in this respect.

According to an embodiment, catalog 601 may include information identifying goods and/or services offered by merchant 602, prices associated with such goods and/or services, related shipping services available, other costs and/or the like. Catalog 601 may also comprise an ID associated with merchant 602 as a participant in a financial transaction system and other merchant profile information.

At block 704, an individual and/or customer associated with customer 604 may review catalog 601 off-line. For example, customer 601 may read a hardcopy version of catalog 601 when away from his or her computing platform, or may view an electronic version of catalog 601 on his or her computing platform when not connected to merchant 602's on-line system (e.g., through a website operated by merchant 602). While viewing an electronic version of catalog 601 off-line, according to an embodiment, an individual and/or customer associated with customer 604 may select items for purchase and click on a “buy” button, from a GUI for example, to begin the purchase process. While viewing a hardcopy version of catalog 601, according to a different embodiment, such an individual and/or customer may select items for purchase and enter associated information to identify the selected items, the merchant 602's ID, a phone number to contact the merchant, and any other related information into software installed on a customer's computing platform. Alternatively, an individual and/or customer associated with customer 604 may make selections using other techniques such as placing an order with a telephone call center operated by merchant. It should be understood, however, that these are merely examples of how an individual and/or customer may make a selection from a catalog and claimed subject matter is not limited in these respects.

At block 706, after selections are made as illustrated above, customer 604's computing platform may contact merchant 602 by, for example, activating a dialing string on a modem which dials a phone number designated by the merchant to take digital orders, sending an email message or transmission of a message 610 using a different communication protocol. Software installed on merchant 602's computing platform may obtain purchase data from customer 604's computing platform, which may be in the form of delimited text for example, and store the received purchase data in merchant 602's database. Optionally, the merchant 602's computing platform may check for inventory levels and/or price changes. If items are out of stock or there has been a price change, software installed on merchant 602's computing platform may reply to customer 604 to give customer 604 the option to revise the order or to proceed. Merchant 602 may have the option to terminate the call and prompt customer 604 to resubmit the order when the changes have been made or maintain a communication session while customer 604 revises the order.

In another embodiment, when a “buy” button in a GUI of customer 604's computing platform is clicked on, the GUI may be directed to the merchant's website on the data network. Upon establishing communication between customer 604's computing platform and the merchant 602's website, information exchanged between the merchant and the customer may be performed over the data network.

At block 708, merchant 602's computing platform may create a purchase order containing merchant 602's ID, a unique order number for the purchase, a dollar amount for the purchase price, and other data such as the merchant 602's email address, URL and/or the like. The purchase order may be transmitted to the customer 604's computing platform in message 612 and stored in a database on the customer 604's computing platform.

At block 710, customer 604's computing platform may transmit RTP message 614 to financial intermediary 606. RTP message 614 may be transmitted over a direct telephone connection and/or IP infrastructure to a computing platform operated by financial intermediary 606, for example. Such an RTP message may include purchase order data from merchant 602 and customer 604's ID and password. As illustrated above, such an RTP message may also comprise information indicative of a privilege level associated with a customer and/or individual initiating the RTP such as, for example, an account number associated with a sub-account of an credit account established on behalf of customer 604. Alternatively, the RTP may also include other information, such as customer survey information, wherein the customer recommends other merchants that may be part of financial transaction system 600. However, this is merely an example information that may be provided in an RTP message and how such an RTP message may be transmitted to a financial intermediary, and claimed subject matter is not limited in these respects.

At block 712, a computing platform operated by financial intermediary 606 may determine whether a received RTP message is from a customer that is registered member of and/or participant in financial transaction system 600. Such a computing platform operated by financial intermediary 606, according to a particular embodiment, may also review information regarding the requested purchase, and determine whether there are sufficient funds and/or credit in a credit account established on behalf of customer 604 to cover the cost of the requested items, for example.

At block 714, a computing platform operated by financial intermediary 606 may determine whether the merchant 602's ID belongs to a registered member of and/or participant in financial transaction system 600. Financial intermediary 606's computing platform may perform other checks on the merchant, such as checking customer service ratings, etc.

As illustrated above according to the particular embodiments of FIGS. 2 and 4, financial intermediary 606 may selectively terminate a transaction or allow a transaction to complete based, at least in part, on a privilege level associated with a customer and/or individual originating an RTP message. As illustrated above with reference to FIGS. 1 through 4, financial intermediary 606 may selectively terminate the transaction or allow the transaction to complete based, at least in part, on a privilege level associated with a particular customer and/or individual forwarding RTP message 614 to financial intermediary 606.

At block 716, if either customer 604 or merchant 602 fail checks performed in diamonds 712 and 714, then a termination message may be sent from financial intermediary 606 to customer 604. Such a termination message may indicate to customer 604 why the requested transaction was terminated. At block 718, after the termination message is sent, the attempted transaction is terminated.

At block 720, if both checks at diamonds 712 and 71.4 pass, then financial intermediary 606 may create a purchase order to transmit to the merchant as shown in message 616. The purchase order may contain information about the items to be purchased, shipping information and payment notification. Contemporaneously, financial intermediary 606 may initiate transfer payment to the merchant via the ACH 620 in message 618.

At block 722, an order confirmation sent from financial intermediary 606 may informs customer 604 that the order has been placed via message 620. At block 724, merchant 602 may ship the requested items to customer 604 at the address specified in the purchase order. At block 726, customer 604 may receive the items requested and the transaction is completed.

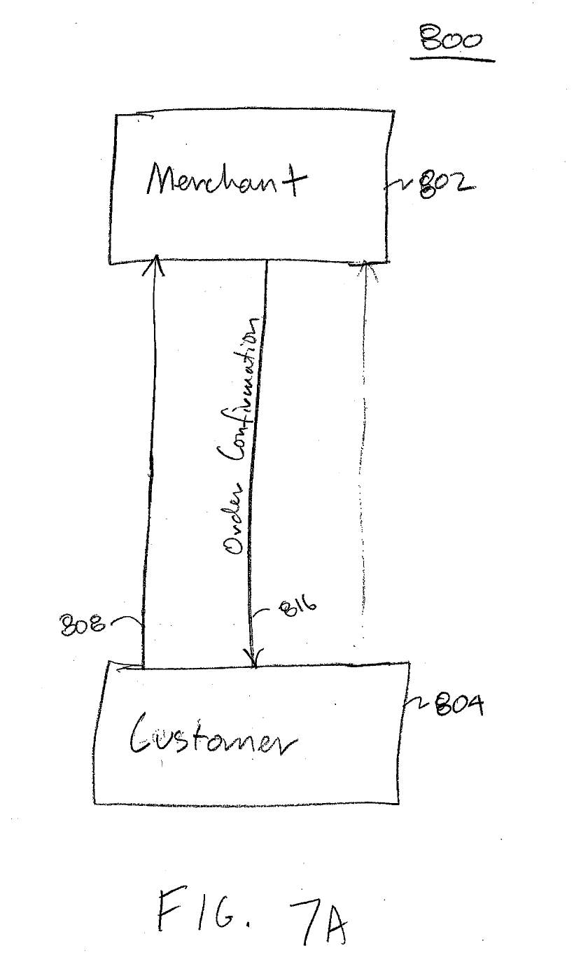

FIG. 7A is a schematic diagram of a financial transaction system 800 according to an embodiment. A credit account may be established with merchant 802 on behalf of an entity enabling multiple customers and/or individuals 804 to purchase goods and/or services from merchant 802 using non-cash transactions financed by the credit account. Here, as illustrated above, a transaction initiated by a customer 804 may be terminated or be allowed to complete based, at least in part, on a privilege associated with customer 804. Accordingly, no other financial intermediaries need be involved to complete such a transaction.

FIG. 7B is a flow diagram of a process for processing an order from a customer according to an embodiment of financial transaction system 800. At block 852, customer 804 may make a selection through a message 808 of goods and/or services available from merchant 802 using any one of the techniques illustrated above (e.g., selection from a website or off-line catalog). At block 854, customer 804 may send a separate payment message (not shown) or include a payment message as a part of message 808. Accordingly, message 808 may comprise an order from customer 804 for the purchase of a good and/or service provided by merchant 802. However, this is merely an example of how a customer may submit an order to a merchant and claimed subject matter is not limited in these respects.

Upon receiving and saving such an order at block 856, merchant 802 may determine whether there is sufficient credit available to customer to fulfill the order at diamond 858 and whether customer 804 is authorized to make the purchase at diamond 860. If there is not sufficient credit available or customer 804 is not authorized to initiate the transaction, the transaction may terminate as indicated by blocks 862 and 863. Otherwise, if there is sufficient credit and customer 804 is authorized to make the transaction, merchant 802 may allow the transaction to complete as indicated by blocks 864, 866 and 868.

Customer 804 may have any one of several credit accounts available to make a purchase from merchant 802 such as, for example, a traditional credit card account to be processed through interactions between merchant 802 and a financial intermediary, a prepaid cash balance established with merchant 802 and/or credit account financed by merchant 802 on behalf of an entity to be used by a plurality of individuals and/or customers to make transactions with merchant 802 on behalf of the entity, and/or the like. However, these are merely examples of a credit account that may be used by a customer in purchasing goods and/or services from a merchant and claimed subject matter is not limited in these respects.

As illustrated above in connection with specific embodiments described with reference to FIGS. 1 through 6, diamond 860 may determine whether a customer is authorized to purchase a good and/or service selected at block 852 based, at least in part, on a privilege level associated with customer 804. Accordingly, and as illustrated above, a plurality of individuals and/or customers may be capable of initiating transactions for the purchase of goods and/or services using non-cash transactions on a single credit account establish on behalf of an entity. However, also as illustrated above, such a transaction initiated by such a customer and/or individual may be selectively terminated or allowed to complete based, at least in part, on a privilege level associated with such a customer and/or individual.

In one alternative embodiment, although claimed subject matter is not limited in this respect, a message 808 may indicate an alternative method of payment to be used if a transaction cannot be completed using a particular credit established with merchant 802. Such an alternative method of payment may be used, for example, if diamond 858 determines that there is insufficient credit available in a credit account and/or diamond determines that customer 804 is not authorized to initiate non-cash transactions using such a credit account as illustrated above. Such an alternative method of payment may comprise, for example, use of a traditional credit account, direct cash withdrawal from a bank account an account established with merchant 802 on behalf of a different entity and/or the, like. In another embodiment, such an alternative method of payment may comprise having credit amounts from sub-accounts of one or more another customers moved to a sub-account of customer 804. Here, for example, customer 804 may be associated with a higher privilege than that of other customers. Accordingly, a portion of credit amounts sub-accounts from other, lower privilege, customers may be re-allocated to the sub-account of customer 804.

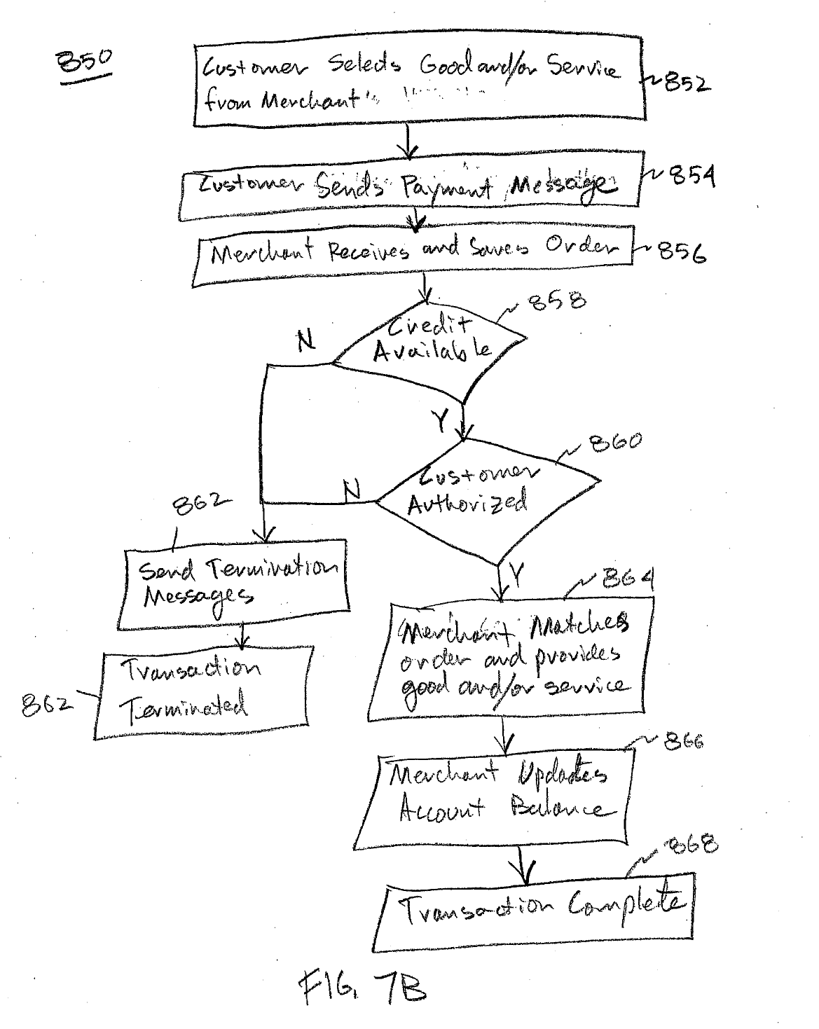

FIG. 8 is a schematic diagram of a computing platform 1000 suitable for use in embodiments of the financial transaction system. For example, such a computing platform may be operated by a customer, seller and/or financial intermediary to facilitate transactions as illustrated above. Here, computing platform 1000 may include display 1002 having display screen 1004, cabinet 1006 to house computer components (not shown) such as a disk drive, CDROM drive, display adapter, network card, random access memory (RAM), central processing unit (CPU), and other components, subsystems and devices, to name a few. User input devices such as a mouse 1008 having buttons 1010, and a keyboard 1012 are shown. Other user input devices such as a trackball, touch-screen, digitizing tablet, however, can be used. It should be understood that computing platform 1000 is merely illustrative of one particular type of computing platform, such as a desktop computer, suitable for use as illustrated above in connection with particular embodiments, and that other types of computing platforms may be used without deviating from claimed subject matter.

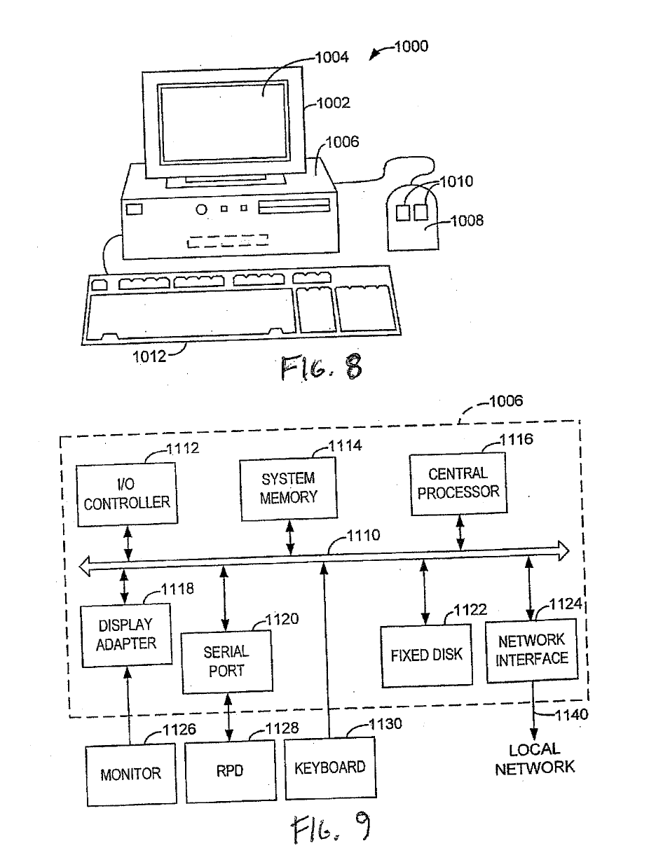

FIG. 9 is a schematic diagram of subsystems of a computing platform such as computing platform 1000 according to a particular embodiment. Subsystems within box, 1006 may communicate via an internal bus 1110. Such subsystems may include input/output (I/O) controller 1112, random access memory (RAM) 1114, central processing unit (CPU) 1116, display adapter 1118, serial port 1120, fixed disk 1122 and network interface adapter 1124. Bus 1110 may allow subsystems to transfer data among the subsystems and with CPU 1116. External devices such as monitor 1126, relative pointing device (RPD) 1128 and keyboard 1130 may communicate with the CPU or other subsystems via bus 1110.

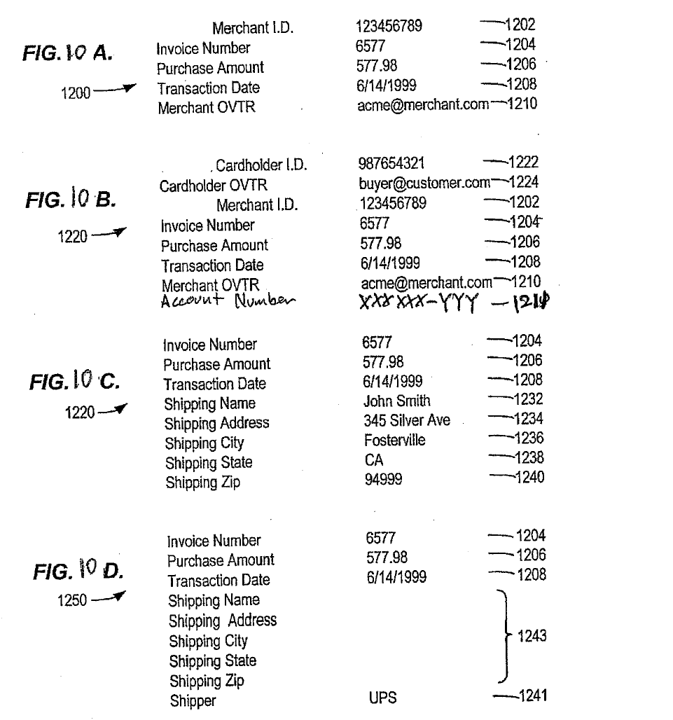

FIGS. 10A-10D show exemplary data formats which may be used during financial transactions described in the above embodiments.

FIG. 10A shows a data format 1200 for information transmitted from a merchant to a customer during operation of an embodiment of a financial transaction system as illustrated above. Data format 1200 includes a merchant ID 1202, an order number 1204, a purchase amount 1206, a transaction data 1208 and a merchant OVTR 1210. Other information in connection with a financial transaction may be included, however. Data format 1200 is intended to be an exemplary list of data items that may be transmitted from a merchant to a customer during operation of a financial transaction system, and claimed subject matter is not limited in this respect.

FIG. 10B shows a data format 1220 for information transmitted from a customer to a financial intermediary during operation of embodiments of a financial transaction system as illustrated above. Data format 1220 includes a customer ID 1222 and a customer OVTR 1224. An account number 1211 associated with a particular individual and/or customer authorized to initiate non-cash transactions may comprise information indicative of a privilege level associated with the particular individual and/or customer as discussed above. Other information in connection with a financial transaction may be included, however. Data format 1220 is intended to be an exemplary list data items that may be transmitted from a customer to a financial intermediary during operation of a financial transaction system, and claimed subject matter is not limited in this respect.

FIG. 10C shows a data format 1230 for information transmitted from a financial intermediary to a merchant during operation of embodiments of a financial transaction system as illustrated above. Data format 1230 may include an order number 1204, purchase amount 1206 and transaction date 1208. Additional information such as a shipping name 1232, a shipping address 1234, a shipping state 1236, a shipping state 1238 and a shipping zip code 1240 may also be included. Other information in connection with a financial transaction may be included, however. Data format 1230 is intended to be an exemplary list of data items that may be transmitted from a financial intermediary to a merchant during operation of a financial transaction system, and claimed subject matter is not limited in these respects.

FIG. 10D shows a data format 1250 for information transmitted from a financial intermediary to a merchant during operation of embodiments of a financial transaction system as illustrated above. Data format 1250 may include an order number 1204, purchase amount 1206 and transaction date 1208. In a particular embodiment, information 1243, relating to a customer's shipping information, can be omitted so that such information given to the merchant only identifies the purchase that has been paid for. Data format 1250 may also include a shipper identifier 1241, so that the merchant is notified of a third party shipper that will handle shipping the purchase to the customer. The customer's shipping information may be given to the third party shipper and may be kept confidential from the merchant, for example. Other information relating to the financial transaction may be included, however. Data format 1250 is intended to be an exemplary list of data items that may be transmitted from a financial intermediary to a merchant during operation of a financial transaction system, and claimed subject matter is not limited in this respect.

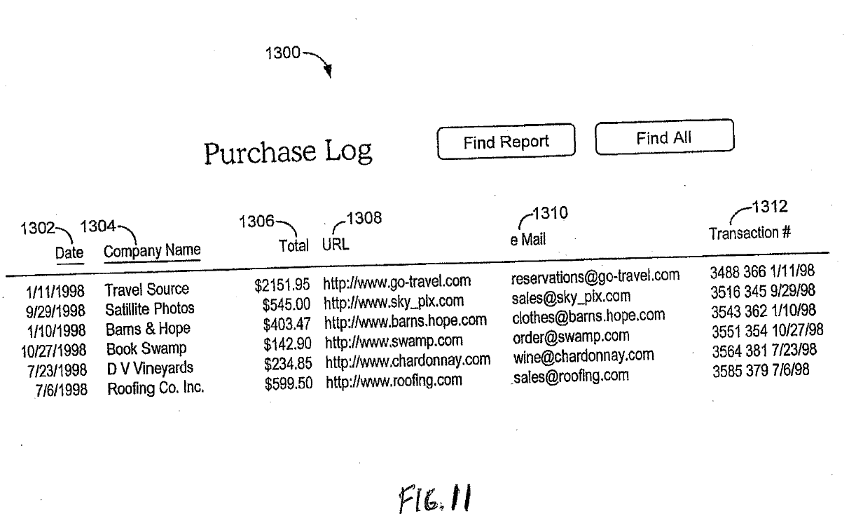

FIG. 11 shows an exemplary purchase log 1300 that may be employed with a financial transaction system as illustrated above and stored on a customer's computing platform. Purchase log 1300 includes a transaction date 1302, a merchant (company name) 1304 and a purchase amount 1306. Purchase log 1300 may also include a merchant URL 1308 or merchant email address 1310, which can be part of the merchant's OVRT. A transaction number 1312 may also be included in purchase log 1300 to enable a customer to reference a particular transaction by transaction number 1312. Other information relating to financial transactions may be included in a purchase log, however. Purchase log 1300 is intended to be an exemplary list of data items that may be included in a purchase log and claimed subject matter is not limited in these respects. A similar purchase log may be maintained by a merchant or financial intermediary. Thus, all parties to a particular transaction may maintain log information, and thereby store a history of financial transaction information.

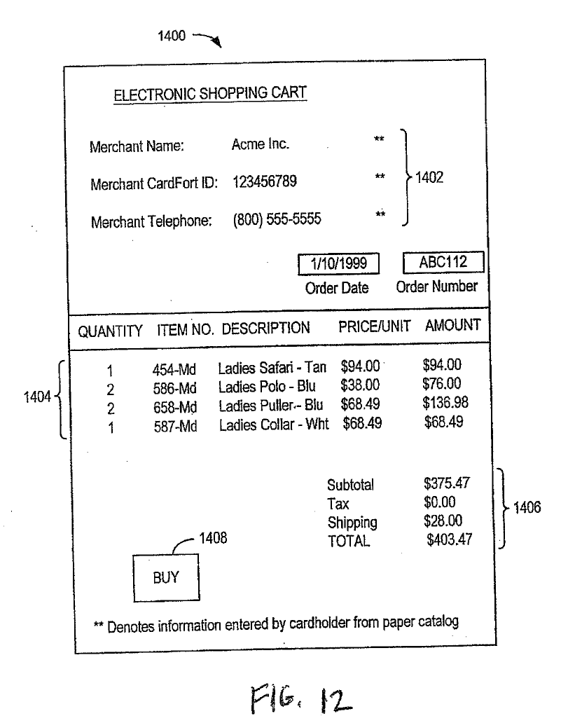

FIG. 12 shows an exemplary electronic shopping cart 1400 which may be displayed in conjunction with a graphical user interface (GUI) of a computing platform operated by a customer. Here, electronic shopping cart 1400 may enable a customer to enter goods for purchase from a merchant. According to particular embodiments, although claimed subject matter is not limited in these respects, electronic shopping cart 1400 may be used in both on-line and off-line operating modes. For example, when a customer is connected to a merchant's web site, the merchant information, as shown at 1402, may be automatically inserted. If an off-line catalog electronic catalog from the merchant is used, the merchant information 1402 may also be automatically inserted. However, if a hardcopy of a merchant catalog is being used, the customer may manually enter merchant information 1402 into electronic shopping cart 1400.

As a selection is entered, item information, shown at 1404, may be entered into the electronic shopping cart. A total is provided at 1406. When the customer has completed making item selections, a buy button 1408, may be clicked on to start the financial transaction as provided in particular embodiments. Therefore, the electronic shopping cart 1400 can be used in both on-line and off-line applications to select item for purchase from a merchant and to activate a financial transaction in accordance with the present invention.

While there has been illustrated and described what are presently considered to be example embodiments, it will be understood by those skilled in the art that various other modifications may be made, and equivalents may be substituted, without departing from the claimed subject matter. Additionally, many modifications may be made to adapt a particular situation to the teachings of the claimed subject matter without departing from the central concept described herein. Therefore, it is intended that the claimed subject matter not be limited to the particular embodiments disclosed, but that the such claimed subject matter may also include all embodiments falling within the scope of the appended claims, and equivalents thereof.

What is claimed is:

1. A method comprising:
receiving an order from one of a plurality of customers initiating a transaction to purchase a good and/or service from a merchant; and
selectively transmitting a payment notification to said merchant based, at least in part, on a privilege level associated with said customer.

2. The method of claim 1, wherein said selectively transmitting said payment notification further comprises selectively transmitting said payment notification based, at least in part, on metadata associated with said merchant.

3. The method of claim 1, wherein said plurality of customers are associated with a credit account, and further comprising affecting an account balance of said credit account in response to completion of said transaction.

4. The method of claim 3, wherein said plurality of customers comprise individuals associated with an enterprise, and wherein said credit account is established on behalf of said enterprise.

5. The method of claim 3, wherein said credit account is associated with one or more credit account numbers.

6. The method of 1, wherein said order comprises an account number associated with said privilege level associated with said customer.

7. The method of claim 6, wherein said one or more credit account numbers comprise a first field associated with a main account and a second field associated with a privilege level.

8. The method of claim 1, wherein said order comprises a credit account number comprising a first field associated with a main account and a second field, the method further comprising determining said privilege level associated with said customer based, at least in part, on said second field.

9. The method of claim 1, and further comprising selectively terminating said transaction in response to said privilege level being insufficient to purchase said good and/or service.

10. The method of claim 1, wherein said transaction comprises a transaction to purchase a good, and wherein said selectively transmitting said payment notification further comprises selectively transmitting said payment notification based, at least in part, on whether said good is depreciable.

11. The method of claim 1, wherein said receiving said order from one of a plurality of customers initiating a transaction to purchase a good and/or service from a merchant farther comprises receiving information from said customer over an Internet Protocol.

12. The method of claim 1, and further comprising determining whether said purchase is subject to a competitive bid requirement based, at least in part, on said privilege level associated with said customer, and wherein said selectively transmitting said payment notification further comprises transmitting said payment notification in response to said purchase meeting said competitive bid requirement.

13. The method of claim 1, and further comprising determining whether said purchase is subject to a price limit based, at least in part, on said privilege level associated with said customer, and wherein said selectively transmitting said payment notification further comprises transmitting said payment notification in response to said purchase meeting said price requirement.

14. The method of claim 13, wherein said order comprises a purchase price, and further comprising obtaining an approximated price associated with said purchase, and wherein said selectively transmitting said payment notification further comprises transmitting said payment notification in response to said purchase price not exceeding said approximated price by a predetermined amount.

15. The method of claim 14, wherein said predetermined amount is based, at least in part, on said privilege level associated with said customer.

16. The method of claim 1, and further comprising determining whether said purchase is subject to a preferred vendor requirement based, at least in part, on said privilege level associated with said customer, and wherein said selectively transmitting said payment notification further comprises transmitting said payment notification in response to said merchant meeting said preferred vendor requirement.

17. The method of claim 1, wherein said order identifies a first vendor, and further comprising

18. The method of claim 1, wherein said order identifies a selected merchant, the method further comprising determining whether said purchase is subject to a preferred vendor requirement based, at least in part, on said privilege level associated with said customer.

19. The method of claim 18, wherein said selectively transmitting said payment notification further comprises enabling transmission of said payment notification to said selected merchant in response to said preferred vendor being incapable of filling said order.

20. The method of claim 19, and further comprising determining whether said preferred vendor is incapable of filling said order by determining whether said preferred has sufficient stock to fill said order.

21. A method comprising:
maintaining a credit account for payment in the purchase of goods and/or services on behalf of an entity associated with said credit account;
receiving an order from one of a plurality of customers associated with said entity, said order initiating a transaction to purchase a good and/or service from a merchant; and
selectively enabling completion of said transaction based, at least in part, on a privilege level associated with said customer.

22. The method of claim 21, wherein said completing said transaction further comprises:
transmitting a confirmation message to said customer; and
adjusting a balance associated with said credit account by an amount based, at least in part, on a price associated with said transaction.

23. The method of claim 21, wherein said wherein said selectively completing said transaction further comprises initiating providing said good and/or service specified in said order.

24. A method comprising:
maintaining a credit account for payment in the purchase of goods and/or services on behalf of an entity associated with said credit account;
receiving an order from one of a plurality of customers associated with said entity, said order initiating a transaction to purchase a good and/or service from a merchant, said one of a plurality of customers being associated with a customer privilege level; and
selectively enabling completion of said transaction in response to said customer privilege level meeting a predetermined privilege level.

25. An apparatus comprising:
a computing platform, said computing platform being adapted to:
receive an order from one of a plurality of customers initiating a transaction to purchase a good and/or service from a merchant; and
selectively transmit a payment notification to said merchant based, at least in part, on a privilege level associated with said customer.

26. An apparatus, said apparatus comprising:
a computing platform, said computing platform being adapted to:
maintain a credit account for payment in the purchase of goods and/or services on behalf of an entity associated with said credit account;
receive an order from one of a plurality of customers associated with said entity, said order initiating a transaction to purchase a good and/or service from a merchant; and
selectively enable completion of said transaction based, at least in part, on a privilege level associated with said customer.

27. An apparatus comprising:
a computing platform, said computing platform being adapted to:
maintain a credit account for payment in the purchase of goods and/or services on behalf of an entity associated with said credit account;
receive an order from one of a plurality of customers associated with said entity, said order initiating a transaction to purchase a good and/or service from a merchant, said one of a plurality of customers being associated with a customer privilege level; and
selectively enable completion of said transaction in response to said customer privilege level meeting a predetermined privilege level.

28. An article comprising:
a storage medium comprising machine-readable instructions stored thereon which, when executed on a computing platform, are adapted to cause said computing platform to:
receive an order from one of a plurality of customers initiating a transaction to purchase a good and/or service from a merchant; and
selectively transmit a payment notification to said merchant based, at least in part, on a privilege level associated with said customer.

29. An article comprising:
a storage medium comprising machine-readable instructions stored thereon which, when executed on a computing platform, are adapted to cause said computing platform to:
maintain a credit account for payment in the purchase of goods and/or services on behalf of an entity associated with said credit account;
receive an order from one of a plurality of customers associated with said entity, said order initiating a transaction to purchase a good and/or service from a merchant; and
selectively enable completion of said transaction based, at least in part, on a privilege level associated with said customer.

30. An article comprising:
a storage medium comprising machine-readable instructions stored thereon which, when executed on a computing platform, are adapted to cause said computing platform to:
maintain a credit account for payment in the purchase of goods and/or services on behalf of an entity associated with said credit account;
receive an order from one of a plurality of customers associated with said entity, said order initiating a transaction to purchase a good and/or service from a merchant, said one of a plurality of customers being associated with a customer privilege level; and
selectively enable completion of said transaction in response to said customer privilege level meeting a predetermined privilege level.

31. An apparatus comprising:
means for receiving an order from one of a plurality of customers initiating a transaction to purchase a good and/or service from a merchant; and
means for selectively transmitting a payment notification to said merchant based, at least in part, on a privilege level associated with said customer.

32. An apparatus comprising:
means for maintaining a credit account for payment in the purchase of goods and/or services on behalf of an entity associated with said credit account;
means for receiving an order from one of a plurality of customers associated with said entity, said order initiating a transaction to purchase a good and/or service from a merchant; and
means for selectively enabling completion of said transaction based, at least in part, on a privilege level associated with said customer.

33. An apparatus comprising:
means for maintaining a credit account for payment in the purchase of goods and/or services on behalf of an entity associated with said credit account;
means for receiving an order from one of a plurality of customers associated with said entity, said order initiating a transaction to purchase a good and/or service from a merchant, said one of a plurality of customers being associated with a customer privilege level; and
means for selectively enabling completion of said transaction in response to said customer privilege level meeting a predetermined privilege level.
